(19) United States
(12) Patent Application Publication
(10) Pub. No.: US 2009/0173889 A1
(43) Pub. Date: Jul. 9, 2009

(54) Fluorescent photopolymerizable resins and uses thereof

(76) Inventors: Santiago Costantino, Montreal (CA); Katrin G. Heinze, Montreal (CA); Paul W. Wiseman, Montreal (CA); Oscar E. Martinez, Buenos Aires (AR)

Correspondence Address: Ralph A. Dowell of DOWELL & DOWELL P.C., 2111 Eisenhower Ave, Suite 406, Alexandria, VA, 22314, US

(21) Appl. No.: 11/921,641

(22) PCT Filed: Jun. 12, 2006
(86) PCT No.: PCT/CA2006/000963

§ 371 Date: Mar. 5, 2008

Related U.S. Application Data
(60) Provisional application No. 60/689,070, filed on Jun. 10, 2005.

(51) Int. Cl. G01J 1/58; G01D 18/00; B29C 35/08

(52) U.S. Cl. 250/459.1; 250/252.1; 264/405

(57) ABSTRACT

There is provided fluorescent photopolymerizable resins for use in biological studies and image acquisition. In particular the photopolymerizable resins are useful in studying the properties of cells. The resins are also useful for the calibration of microscopic measurement systems.

### FIELD OF THE INVENTION

The present invention relates to photopolymerizable resins and their use for biological/biophysical applications.

### BACKGROUND OF THE INVENTION

Recently, two-photon polymerization of UV-light curing resins has been shown to be effective for generating 3D structures of only several microns in size for photonic applications (Cumpston et al. (1999) Nature 398, p. 51-54; Galajda et al. (2001) Appl. Phys. Lett. 78 (2), p. 249-251; Hong-Bo et al. (2000) Optics Letter 25(15), p. 1110-1112). Cumpston has shown that you can make pyramids and cantilevers, etc. for three-dimensional fluorescent imaging for optical data storage and lithographic microfabrication. Galajda and Ormos combined two-photon polymerization and laser induced trapping (‘laser tweezer’) to create and manipulate microscopic light driven rotors. In their work, two-photon polymerization of a UV-light curing resin (NOA 63) has been applied to generate effective rotating particles several microns in size; even mechanical devices consisting of multiple moving parts driven by these rotors have been produced.

Hong-Bo et al. have done similar work creating 3-dimensional microstructures with submicrometer resolution. To push the limits further and to overcome the often faced problem of drift and distortion creating complex geometries, they utilized a pre-exposure technique by which the viscosity of resins were increased and the solidified elements tightly confined at the exposure site.

Photolithography is based on traditional ink-printing techniques; lithography is a process for patterning various layers, such as conductors, semiconductors, or dielectrics, on a surface. A typical integrated circuit consists of various patterned thin films of metals, dielectrics and semiconductors on various substrates such as silicon, gallium arsenide, or germanium. In lithography, radiation sensitive polymeric materials called resists are used to produce circuit patterns in the substrates. Nanopattering expands traditional lithographic techniques into the submicron scale. In terms of photomasks, nanometer resolution remains a challenge, since the selective chemical etching is performed based in diffraction-limited optical imaging. Even though not proved yet, two-photon photopolymerization, given the nonlinearity of the process, could in principle overcome the diffraction limit.

The resist material is applied as a thin coating, typically by spin coating over the substrate (wafer) and then heated to remove the casting solvent (post-apply bake, pre-exposure bake, or pre-bake). The resist film is subsequently exposed in an image-wise fashion through a mask (in photo- and X-ray lithography) or directly with finely focused electron beams. The exposed resist film is then developed typically by immersion in a developer solvent to generate three-dimensional relief images. The exposure may render the resist film more soluble in the developer, thereby producing a positive-tone image of the mask. Conversely, it may become less soluble upon exposure, resulting in generation of a negative-tone image. When the resist image is transferred into the substrate by etching and related processes, the resist film that remains after the development functions as a protective mask. The resist film must “resist” the etchant and protect the underlying substrate while the bared areas are being etched. The remaining resist film is finally stripped, leaving an image of the desired circuit in the substrate. The process is repeated many times to fabricate complex semiconductor devices.

For a resist material to be useful in device fabrication, it must be capable of spin casting from solution into a thin and uniform film that adheres to various substrates such as metals, semiconductors, and insulators, it must possess high radiation sensitivity and high resolution capability, dictated by solubility/insolubility characteristics, withstand extremely harsh environments, for example, high temperature, strong corrosive acids, and plasmas such as used in subsequent etching, doping and sputtering operations.

Microfabrication of structures and masks is required in various fields of biophysical research and biotechnology industries (Blawas et al. (1998) Biomaterials 19, p. 595-609; McAlear et al. (1976) U.S. Pat. No. 4,103,073; Clark et al. (1988) U.S. Pat. No. 4,728,591). It serves as an important tool particularly for creating protein patterns with defined spatial arrangement and micron and submicronscale features for studying cellular-level interactions (Lehnert et al. (2004) J. Cell Sci. 117(1), p. 41-52; Matsuda T. et al. (1993) U.S. Pat. No. 5,202,227), including basic cell-cell communications (Karp et. al. (2003) J. Craniofacial Surgery 14(3), p. 317-323), cell signalling (Sorribas et al. (1999) PSI, Annual Report), and mechanisms of drug action.

The present state of the art uses expensive and time-consuming lithographic techniques in order to make bioactive patterns on biocompatible substrates, such as glass-coverslips (Madou (2002) CRC Press; Lehnert et al. (2004) J Cell Sci. 117(1), p. 41-52).

Moreover, in the last century, the biotechnology industry shifted toward the use of ultra-sensitive measurement techniques, often based on fluorescence methods involving different kinds of imaging and spectroscopic capabilities to open the field of cell and gene manipulation or proteomics. These techniques often require not only high-resolution microscopes, but also tailored inert substrates with high-resolution calibration markers to identify, adjust and control the detection process.

The ability to engineer and control the interactions of cells with biomaterials is critical for cell biology studies, medical implants, and functional biomaterial scaffolds for tissue engineering, as well as for the development of cell integrated biochips used in cell-based sensors and “lab-on-a-chip” bioanalytical systems. The controlled attachment of desired cell populations (Svedhem et al. (2003) Langmuir 19 (17), p. 6730-6736) using specific cell-signalling molecules or adhesion ligands in precisely engineered geometries will enable production of truly bioactive systems with a broad spectrum of applications (Sorribas et. al. (1999) PSI, Annual Report; Lehnert et. (2004) J Cell Sci. 117(1), p. 41-52). Understanding cell behaviour and geometry is one key for enhanced tissue engineering (Karp et al. (2003) J. Craniofacial Surgery 14(3), p. 317-323) to design optimized artificial surfaces that e.g. ‘naturally’ interact with tissue culture. Modern microfabrication of respective structures and patterns of bioactive molecules is one of the most powerful tools for probing cell adhesion, spreading and migration or even networking in the case of neurons (Lehnert et al. (2004) J Cell Sci. 117(1), p. 41-52; Sorribas et al. (1999), PSI Annual Report).

The manufacture of DNA chips has been one of the hottest area of biotechnology since early 1990's when innovative researchers took the robotics and lithographic patterning technology used in making silicone microelectronics and applied them to DNA analysis. They were able to attach thousands of pieces of genetic material to glass slides or plastic wafers and use these “chips” to identify DNA in a sample of interest. These DNA chips are now widely used in medical research but making protein chips is far more vexing. While DNA is pretty sturdy, proteins are very fragile. Proteins are folded strings of subunits called amino acids, and the activity of proteins depends on the precise three-dimensional folding of these subunits. Outside of a narrow range of environmental conditions, proteins will “denature” i.e. the amino acid chain will lose its 3 dimensional structure, collapse and will loose its biological activity.

The present lithographic techniques for making protein chips use U.V. light and strong acids that are detriment to the protein activity. The micro contact printing technique, involving patterning self-assembled monolayers of alkane thiols onto gold surfaces, leads to very low density of proteins on the surface due the inherent problems in transfer efficiency. The microfluid network technique, which involves a high aspect ratio of PDMS capillary channels involves very poor mass transfer of the proteins under study due to the collapse of the capillaries and blockage. The spotting or spraying techniques involving electro deposition cannot be effectively used for protein chips because the protein activity cannot be retained upon charging of the droplets or upon its deposition onto a charged surface.

Grid structures such as spatial imaging reference are required to identify microscopic areas of interest on a macroscopic substrate if migratory behaviour of an individual cell is to be analyzed. Even though diamond etched grids on glass coverslips are commercially available (e.g. from Bellco Glass inc., Vineland, N.J., USA) for studies involving cell counting, unfortunately they are invisible in a confocal microscope using fluorescence detection and, therefore, useless for this common type of imaging. Furthermore, the shapes of the so far commercially available etched patterns are not custom made. Depending on the cell type, the cell size, spatial dynamics of the cell as well as the underlying scientific questions the requirements for such patterns vary in scale, size and type.

There is therefore a need for better methods and technologies in the field of biocompatible microstructures.

### SUMMARY OF THE INVENTION

In one aspect of the invention there is provided a method for microscopic observation of one or more objects comprising providing a support means having a surface comprising a cured resin exhibiting a pattern on the surface, the resin comprising a light emitting substance; placing the one or more objects on the support; and simultaneously visualizing the one or more objects and the cured resin.

In another aspect there is provided a method for calibrating a fluorescence measurement apparatus the method comprising providing a support means having a surface comprising a cured resin exhibiting a pattern and comprising a fluorophore with known fluorescence characteristics; obtaining fluorescence measurements of the fluorophore with the apparatus; an comparing the measurements with a least one of the known fluorescence characteristics to provide a calibration of the apparatus.

In yet another aspect there is provided a method for performing electrophysiological studies on cells the method comprising providing a support means having a surface comprising a cured electrically conducting resin exhibiting a pattern; placing one or more cells on the surface such that at least one cell is in contact with the resin; and measuring an electric current within the resin generated by the at least one cell.

In an embodiment of the invention a method for making microstructures on an imprintable substrate is provided the method comprising providing a two-photon photopolymerizable resin; curing the resin on a surface according to a desired pattern; and imprinting the imprintable substance using the cured resin to obtain a pattern on the substrate corresponding to the desired pattern.

In another embodiment there is provided a method for making protein patterns on a support the method comprising curing a two-photon photopolymerizable resin on the support according to a desired pattern; coating the support with a protein solution; and removing the cured resin thereby creating a protein pattern on the support.

In yet another embodiment there is provided a method for making protein patterns on a support the method comprising curing a two-photon photopolymerizable resin on the support according to a desired pattern; adsorbing proteins on the cured resin.

In still a further embodiment there is provided method for making biocompatible compartments on a support the method comprising: curing a two-photon photopolymerizable resin on the support according to a desired pattern thereby creating compartments; and incorporating biomolecules in the compartments.

There is also provided structures and supports comprising cured resins such as fluorescent resins for use in the methods described herein.

### BRIEF DESCRIPTION OF THE DRAWINGS

Further features and advantages of the present invention will become apparent from the following detailed description, taken in combination with the appended drawings, in which:

FIG. 1 is a schematic representation of an embodiment of the apparatus used to cure resin pattern on supports;

FIG. 2 is an example of the reproduction of an image into a resin pattern;

FIG. 3 are confocal fluorescence images of A) live CHO cells stably transfected with α-5 integrin EGFP, B) Rat hippocampal neurons (10 DIV) immunostained for MAP2 (mouse antibody HM-2, Sigma, revealed with goat anti-mouse Alexa 546 Molecular Probed) and C) Rat hippocampal neurons (12 DIV) transfected with GFP;

FIG. 4 are confocal-fluorescence images of a GFP protein pattern (A bright areas) after removing the grid. In B and C Partially peeled off resin grid structure is shown. The dark lines indicate the areas that were covered by the polymerized resin. To prove that the bright pattern is due to fluorescence and not to light scattering on the glass surface, photobleaching of fluorescence was induced within a squared area onto the pattern (C);

FIG. 5 is a confocal fluorescent image of GFP pattern with the non-fluorescent grid still on the support (shown as dark lines);

FIG. 6 A is DIC image of a PDMS stamp created using the described method;

FIG. 6 B is a fluorescence confocal microscopy image showing a solution of a fluorophore in ethanol printed on a cover slip with a PDMS stamp;

FIG. 7 is a model of a possible fluorescent calibration grid;

FIG. 8 is a fluorescence image of a hippocampal neuron fluorescently transfected with GFP on a fluorescent grid;

FIG. 9 is a confocal microscopy image of GFP adsorbed onto a resin pattern;

FIG. 10 A is a schematic representation of a cured resin pattern to be used as a mold;

FIG. 10 B is a schematic representation of the mold of FIG. 10 A with polymerized PDMS;

FIG. 10 C is a laser scanning microscope image of a T-shaped microstructure filled with a solution of fluorescent microspheres (diameter of 1 μm); and

FIG. 11 is a fluorescence image of A) CHO cells expressing α5-integrin/EGFP fusion constructs plated on a patterned substrate with a mixture of fibronectin and Alexa633 labeled human fibrinogen (Molecular Probes) and B) and C) pattern of poly-D-lysine/EGFP on a glass substrate, allowing rat hippocampal neurons (immunostained for MAP2) to grow their neurites in specific corridors.

### DETAILED DESCRIPTION OF THE INVENTION

In a broad embodiment of the invention, there is provided cured resins coated materials for use in, but not limited to, biological and biophysical applications. The cured resins are preferably produced by two photon photopolymerization to create desired structures and patterns that can be advantageously utilized in various applications as will be further described below.

In one embodiment of the invention, the resins preferably comprise light emitting molecules such as fluorophores. UV-cured adhesives are used solely or mixed with a fluorophore, or fluorescent micro spheres, and can be polymerized by two-photon absorption using a femtosecond or picosecond light source to cure the resins. The polymerized glass-like structures are created by moving a diffraction limited laser focal spot along the glass surface. As a consequence of the two-photon induced inherent sectioning, the solutions are only cured within the vicinity of the focal spot. Method for curing resin using two-photon polymerization are well known in the art. After micromachining, the excess of non-polymerized resin can be easily rinsed by alcohol or/and acetone. Flexible selection of commercially available fluorophores is possible, since polymerization is observed over a broad wavelength range. Thus, the wavelength used for polymerization can be easily adjusted to minimize photo-bleaching of the fluorophore of choice.

In one embodiment of the invention, variable dimensions of the cured resin areas can be obtained by adjusting the average laser power and the scan velocity. Higher laser power resulting in an increase in polymerization and accordingly in a larger area or volume of the resin being polymerized.

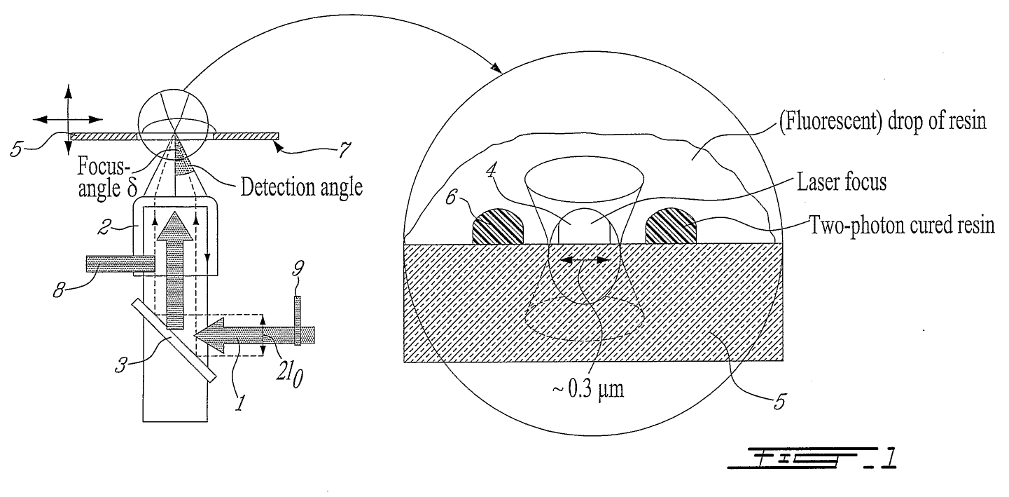

FIG. 1 describes a non-limiting example of an experimental procedure used for creating fluorescent structures on standard microscope glass coverslip. The experimental setup comprises a microscope objective with high numerical aperture and a tunable Ti:Sa laser 1 in fs-configuration for two-photon excitation. The parallel laser light epi-illuminates a water-immersion UplanApo60×1.2 objective 2 via a silver coated mirror 3. The back aperture is slightly overfilled creating a diffraction-limited spot 4 partially above the glass coverslip 5. The glass coverslip is coated with the resin or resin-fluorophore mixture which gets polymerized by a two-photon process only in the vicinity of the small focal spot 6. The coverglass is mounted on a motorized stage that provides movements in x- and y-direction 7. The z-position is adjusted by the back-reflection spot from the coverglass with an actuator 8 and can be kept constant while micro-machining. A laser shutter 9 provides the machining of non-connected structures in a continuous process.

The objective may also be displaced in the z direction to move the focus of the light beam in that direction. Such a displacement allows the control of the polymerization of the resin in the z-direction (depth).

The coverglass is positioned on a platform that can move in two perpendicular directions. This movement is performed by two translation stages that are driven by DC motors. The motors are computer controlled and have built-in optical encoders that can provide submicron positioning. Software program can control the motion of the various parts of the system. For example, a program was implemented in LabVIEW 7.0 (National Instruments) to control the movement of the two motors and a laser shutter as well. This custom-made LabVIEW application reads a text file that has the commands for the motors and shutter. The specially designed format of the text file is as follows:

Position Motor1 (tab) Position Motor2 (tab) Shutter On/Off (tab) Velocity Motor1 (tab) Velocity Motor 2 (LF).

The sequence of positions, velocities and state of the shutter, determines the spatial shape of the desired pattern. This design allows the flexibility of using any desired tool in order to create the text file with the set of instructions. The LabVIEW program sequentially sends the commands to the motors to go to the positions specified in the text file.

A typical, non-limiting example of the sequence of the manufacturing process involves the following steps:

1. The laser beam is coupled into the objective.

2. A glass coverslip is placed above the objective and adjusted via the laser back reflection off the glass coverslip.

3. The laser beam is blocked.

4. A drop of resin (NOA 60) is placed onto the coverglass.

5. The computer controlled machining process starts moving the xy-motorized stage and opening the laser shutter inducing polymerization of the laser exposed resin.

6. After machining the two-photon cured resin is finally attached to the cover glass covered by the incured drop of resin.

7. For cleaning the uncured resin is rinsed off with an ethanol and acetone solution and blown dry with nitrogen.

8. Only the cured structure remains attached to the glass-coverslip and can be stored for later use.

However it will be appreciated that the sequence of events may differ from the above as would be appreciated by those skilled in the art.

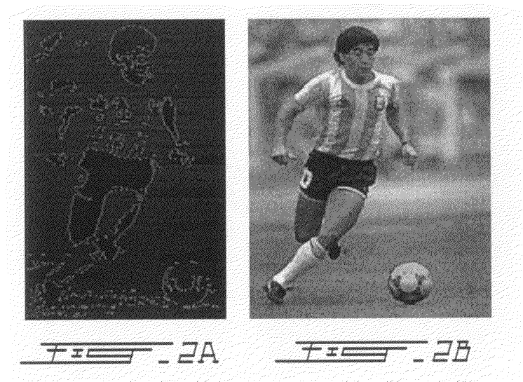

In one aspect of the invention images can be reproduced as a cured resin pattern. The image reproduction as a cured resin can be advantageously visualized by using a resin comprising a fluorophore. The fluorophore may be incorporated directly in the resin or as part of a conjugate with another molecule. Thus, graphic format files can be converted into instructions for a photopolymerizing system to generate the proper parameters to reproduce the image. For example, an application was developed in Matlab to convert any graphic format files (tif, gif, jpg, etc) into a text file with the instructions set for the motors. First, the image is converted into black & white and then a custom intensity threshold is established to make a 1 bit color depth image. Using these tools it was possible to create a cured fluorescent resin pattern using a photograph as shown in FIG. 2.

In one embodiment of the invention, fluorescent cured resin of the present invention can be advantageously used for calibrating fluorescent measurement apparatus such as fluorescent microscopes. The fluorescent resin can be cured on an appropriate surface with well-characterized fluorescent patterns and intensity enabling a precise calibration of an apparatus. The two-photon process can create three-dimensional microstructures that are particularly useful to calibrate measurements for objects that exhibit three-dimensional inhomogeneities.

In another embodiment of the present invention, there is provided a method for the microscopic observation of objects. The method comprises providing a transparent support that has been treated to generate a pattern of a cured resin with the desired three-dimensional pattern and comprising a fluorophore. For microscopic applications, the support is preferably a transparent glass support, such as a microscope slide. Objects can then be placed on the transparent support and examined under a fluorescence microscope. Advantageously the fluorescent resin pattern allows the determination of the relative positions of the objects. In a preferred embodiment, the one or more objects can be fluorescently labeled or can possess an intrinsic fluorescence which enables a better simultaneous visualization of the resin pattern and the objects. The emission wavelength of the fluorescence of the resin in the objects can be the same, but using fluorophores exhibiting different emission wavelengths will enhance the contrast of the image.

It will be appreciated that the method enables the observation of objects that are capable of motion. The grid pattern on the support allows one to record the motion of such objects. For example, certain types of cells, such as neurons, may exhibit axonal or dendritic growth as a function of time and environmental conditions. It is highly desirable to be able to record the spatial localization of such outgrowth for physiological studies and the like. The fluorescent resin pattern can be used to that effect.

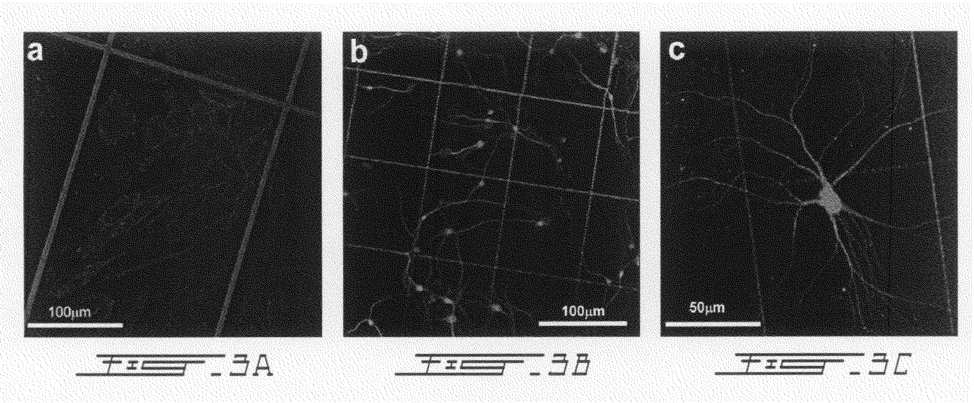

For this purpose resin that are inert to biological material are preferably used. For example, pulsed Ti:Sapphire laser irradiation of commercial adhesives (e.g. NOA60, NOA61, NOA 63, Norland Products, Norland, N.J., USA) through a high numerical aperture microscope objective allows for the fabrication of custom-made bio-compatible fluorescent structures with submicrometer dimensions. These convex structures have been shown to be robust, resisting typical coating, cleaning and sterilization procedures required for cell culture use. Cultured adherent cell-lines as well as neuronal primary cultures have been proven to adhere and also grow along the structures demonstrating that the polymerized material is physiologically inert (FIG. 3). The person skilled in the art would be capable of testing resin for their compatibility towards biological material and as such resins other than those mentioned above can be used to enable the methods of the present invention.

In yet another embodiment of the invention, supports exhibiting cured resin patterns can also be used for physiological studies. For example, the resin can be selected to be electrically conductive, therefore providing a defined two or three-dimensional electrical pattern on which a certain type of cell can be placed to study the response of such cells to electrical impulses. Alternatively, cells such as neurons that are capable of producing electrical impulses can also be studied whereby the electrical impulses of the neurons can be recorded as a function of position by detecting electrical current in the resins at desired places.

There is also provided a method for making microstructures on an imprintable substance whereby the resin can be cured on the surface of an object with a desired pattern and this pattern can be imprinted on an imprintable substance by overlaying the substance on the pattern. The pattern of the resin is thereby transferred to the imprintable substance, which can in turn be used for diverse purposes such as microfluidic applications. The imprintable substance can be, but is not limited to elastomers.

A resin pattern on a surface can also be used for making molecular patterns such as protein patterns. For example, a resin pattern on a surface can be treated with protein solution such that the proteins can be adsorbed to the resin pattern. The proteins may also be mixed with the resin prior to photopolymerization.

In another embodiment, the pattern may also be used to form compartments on a surface. These compartments, which can be tailored to the intended use, may be useful for containing small objects such as cells.

### EXAMPLES

### Example 1

There is described inert, fluorescent glass-like structures on glass surfaces on a micro and submicrometer scale for cell culture use or as fiduciary calibration marks in fluorescence microscopy (see FIG. 3).

Red fluorescent grids were fabricated and utilized as a substrate for culture of eGFP-5-transfected CHO cells and fluorescently tagged commissural primary neuronal cell cultures. This strategy allows for the implementation of dual color imaging with negligible signal cross-talk between channels. Both cell types did not show any visible physiological difference with the cells cultured in coverglasses without the fluorescent patterns indicating the chemically inert nature of the polymerized material for practical purposes.

Standard glass coverslips (Fisher Scientific) were cleaned and used as a substrate for fluorescent grids (FIG. 3 A-C) using commercially available resins mixed with fluorescent beads or a fluorescent dye (here: ADS675MT, American Dye Source, QC, Canada) polymerized by two-photon absorption. After laser micromachining and rinsing the cover slip with ethanol and acetone, CHO cells (FIG. 3A) were plated onto the cover slip. Live-cell imaging was performed two days later. For neuronal cultures (FIG. 3 B,C) grid cover slips were additionally coated with poly-d-lysine and then sterilized by 15 min UV-treatment before plating cells.

### Example 2

There is described polymer structures that can be used as rubber stamp matrices to replace standard Silicon wafers.

In typical protein patterning experiments (Singhvi R. et al. (1994) Science, 264:696-8) PDMS stamps are produced using micromachined silicon wafers as matrices. In order to replace this expensive technology, the above described UV-cure adhesive structures can be used. Grid structures were created on standard coverglasses. PDMS rubber stamps were prepared by using a 10:1 ratio (v/w) of elastomer to hardener, put onto of the grid and cured for 20 minutes at 120° C. They were then separated from the structured glass and light microscopy was used to examine the quality of the negative rubber patterns.

### Example 3

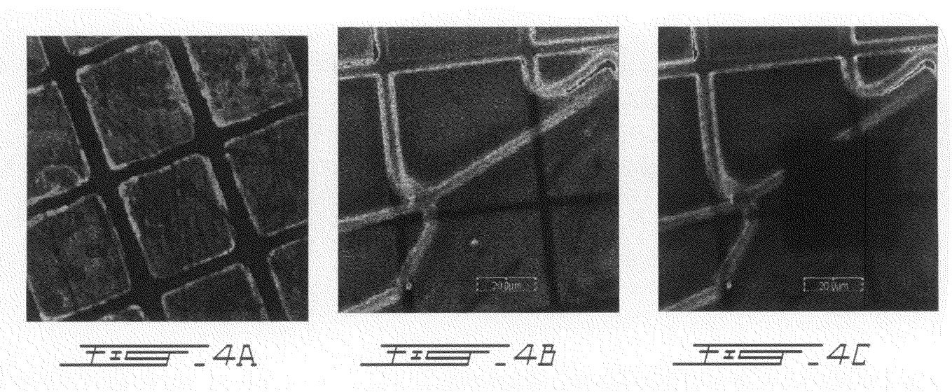

There is described UV-cured structures that can serve as mask for protein patterning. For this experiment, the cover slip comprising the cured resin was coated with recombinant Green Fluorescent Protein (GFP, Clonetech) by incubating the grid coverslip 50 μg/ml GFP solution for 30-60 minutes at room temperature (or overnight at 4° C.) and then rinsed with buffer solution. The resin was mechanically removed by a metal tweezer or sonication. As shown in FIG. 4 the micromachined structure serves as a mask for protein coating.

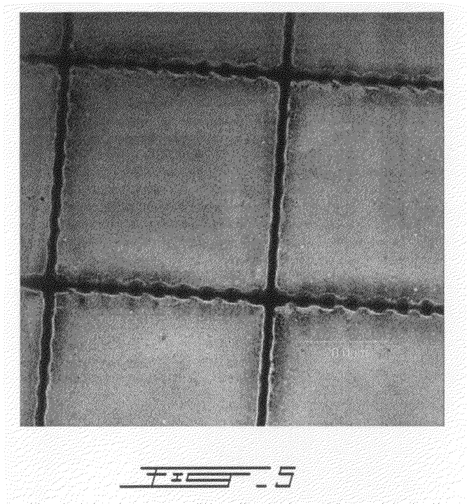

After removing the resin a protein pattern is created, indicated by the GFP protein fluorescence (bright) and non-fluorescent areas (dark) in the images (FIG. 5). If a specific 3 dimensional topology of the structure is wanted, it is also possible to (partially) leave the resin after coating (FIG. 5B). The resin could also be removed by irradiating the structures with light pulses generated in a Q-switched Neodimium-YAG laser if the UV-cure adhesive is mixed with highly absorbing compounds such as dark inks. The sudden expansion caused by the heating of the darkened polymer produces a shock wave that violently removes it from the glass coverslip.

### Example 4

There is described an embodiment of the invention in which resin patterns are used to separate functionalized region of the support (FIG. 5). For this experiment, GFP protein was covalently bound to the glass surface by a commercially available cross-linker kit (Pierce Biotechnology, Rockfort, Ill., USA) before curing the resin to avoid rinsing off the protein coating when washing the coverslip.

The resulting non-functionalized resin grid structure physically separates the compartments coated with protein. Such physically restricted ‘neutral’ wall of the grid pattern makes it possible to study cell behaviour on functional substrates in strongly confined areas. For example, cell adhesion, spreading and migration require the dynamic formation and dispersal of contacts with the extracellular matrix (ECM). Cell mobility e.g. is highly dependent on the accessibility and distribution of the ECM binding sites. Typical questions to be addressed are: What is the minimum size of those ECM protein areas and what the minimum distance to be recognized or accepted for adhesion by a certain cell type? What happens if the pattern shows a protein gradient? What is the maximum height of the wall to allow a certain cell type to overcome the barrier under certain conditions or stress?

### Example 5

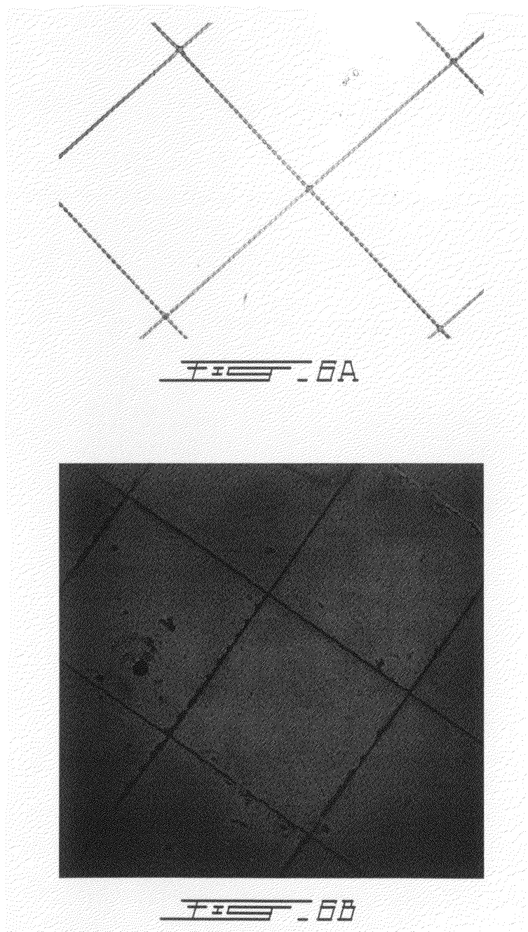

A resin pattern on a surface can be used as a master for preparing “stamps”. For example, after the resin has been cured on a cover slip a drop of PDMS (Polydimethylsiloxan, Sylgard 384, Dow-Corning) was placed on top of the coverslip, polymerized at 120° C. for 20 minutes and then removed from the coverslip creating an elastomeric ‘stamp’. The so-called PDMS stamp (shown in FIG. 6A and B) can be used for patterning dye and/or protein solutions. For example, pattern of fibronectin mixed with Alexa633 fibrinogen provides small islands of adhesive substrate for individual CHO cells to grow (FIG. 11A). This approach can be used for selecting single cells for generating clonal cell lines or for neuronal microcultures. In FIG. 11 B and C poly-D-lysine mixed with GFP guides and confines neurite outgrowth from neonatal hippocampal neurons (4 days in vitro (DIV)). This approach can be used for example to test the role of extra-cellular matrix proteins for nerve regeneration studies.

### Example 6

Cured fluorescent resin patterns can also be used for fluorescence calibration for fluorescence microscopy, including confocal microscopy, or spatial references for imaging and fluorescence cell counting.

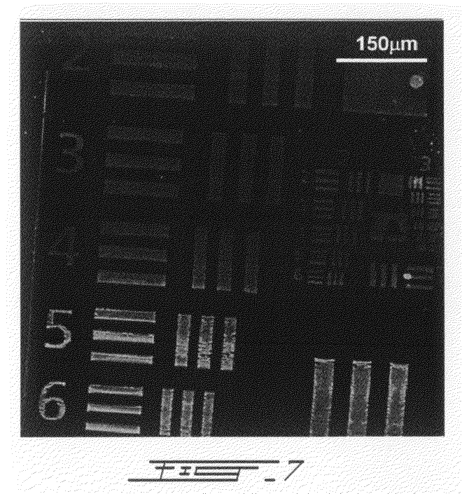

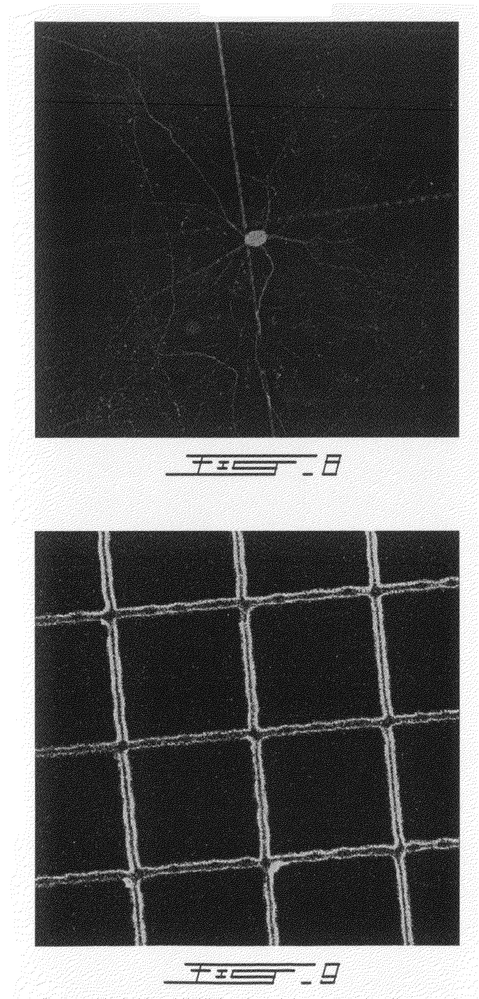

An example of calibration grid is shown in FIG. 7. The micromachining of dotted and dashed lines can be made using a shutter assisted setup, periodically blocking the. laser beam while moving along the substrate surface.

A fluorescent micro-marker on a standard coverglass can be used for example for:

Calibrating and scaling a fluorescent microscope setup or/and a fluorescent image or parts of the image created by classical fluorescence microscopy or laser-scanning microscopy [e.g. Zeiss, Olympus, Leica and Nikon sell those microsopes];
for identification of a single cell of interest on a surface in long term or multiple analysis.

The use of a fluorescent grid made according to this invention overcomes an important problem with the current technology which makes use of etched glass slides (grid) and one must switch between transmission light and fluorescence light in the microscope to visualize the grid. Therefore, the grid will not appear in the final fluorescence image to verify or mark the position of interest. The use of cured fluorescent resin according to the present invention overcomes this limitation of the prior art.
for (Fluorescent) cell counting within a fluorescence microscopic setup (cell viability, transfection or infection check).

Similarly, the use of a fluorescent grid according to the present invention allows fluorescent cells counting in the fluorescence mode.
as fiduciary markers for cell motion quantification

Cell motility and adhesion play key roles in organism development, physiology and disease. Movement requires coordinated regulation of cellular protrusions, adhesion, contractile forces and rear detachment. Migrating cells must respond to a plethora of diffusible and surface bound environmental cues and integrate these signals to coordinate the dynamic cytoskeletal remodeling underlying movement. In the past few years, advances in imaging, biochemical purification and genetics have resulted in an explosion in the study of movement at the molecular, cellular and organism levels. The different aspects of cell migration and recent developments in the field reflect the need for new emerging technologies.

Typically, motion is measured using features in the samples that seem to remain immobile during the image time series acquisition. The fluorescent resin of the present invention enables displacement to be measured relative to the grid pattern.
as spatial references in dynamic imaging (time lapse or z-stacks)

For sophisticated image analysis such as fluctuation analysis, the microscope stage needs to be strictly immobilized in xyz coordinates during the data acquisition process and for time series the stage needs to be at exactly the same position from image to image. Drifts in position of the stage can be compensated or measured using fluorescent microstructures of the present invention as spatial references.

### Example 7

In an embodiment, structures of fluorescent conductive resins that can be used for non-invasive cell excitation in electrophysiogical studies are provided.

Such conducting resins can be made using a commercially available conductive adhesive (e.g. NCA 130, Norland Products, Norland, N.J., USA) with and without adding a fluorescent component. These structures can be used as micro-wires to excite living cells allowing for electrophysiological studies with custom made micro circuitry.

### Example 8

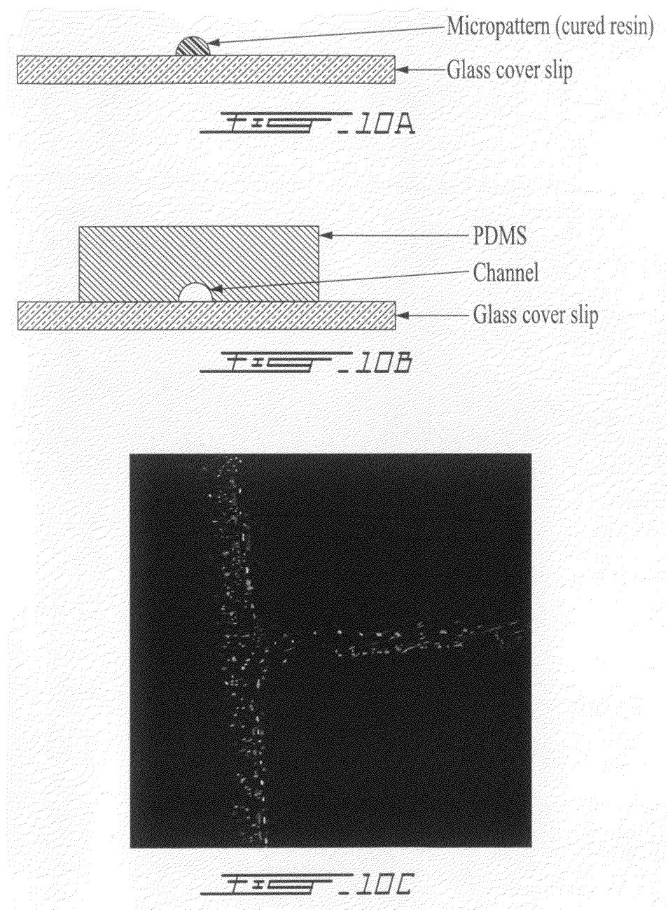

In another embodiment the resin pattern can be used as an adsorbing structure thereby dictating the pattern of an adsorbed molecule or object. In this example, we have made a grid (non-fluorescent) onto which green fluorescent protein GFP is adsorbed (see FIG. 9). As the adsorption properties and behavior of GFP and other proteins are comparable, adsorption of proteins in general, including antibodies, to the resin can be achieved to provide desired protein patterns. This experiment demonstrates that the method can be used to provide a molecular pattern that can be used to various ends. For example, immobilized biosensors on a resin pattern can be used to capture toxins or other pathogenic products for detection purposes.

In the example shown on FIG. 9 the grid on the coverglass was incubated during 15 minutes in a GFP solution of 0.1 mg/ml and then rinsed with buffer solution. The confocal image was collected immediately after.

### Example 9

In this example, a graphic file was transformed into a fluorescent pattern (see FIG. 2). The width of this pattern is 0.5 mm.

### Example 10

In yet another example the methods and photopolymerizable resin of the invention can be used to create microfluidic devices.

### Fabrication of the Microchannels.

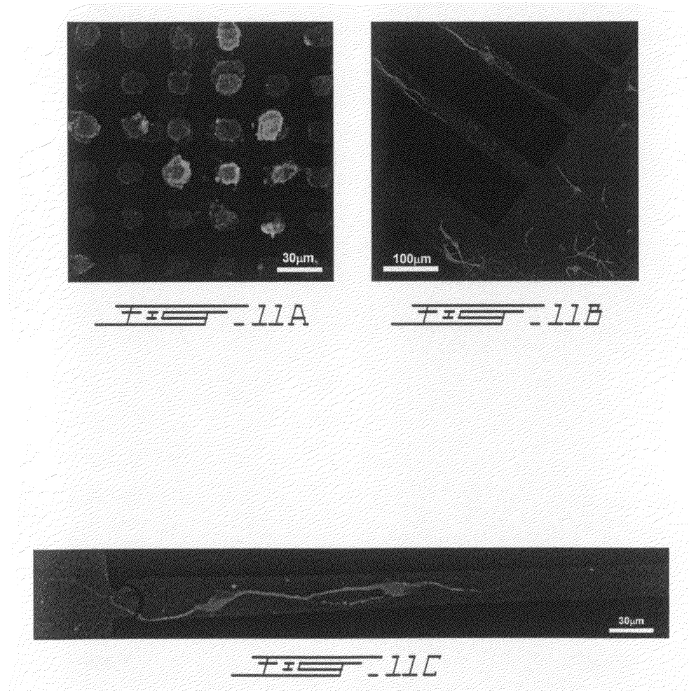

The microstructures were cast from two-photon micromachined structures comprising the channel geometry and topology in the negative (upstanding) form (FIG. 10 A). The main channel of the structure shown here was ˜25 μm wide and ˜2 μm deep. The lengths of all microchannels were 2 mm. Large numbers of cheap and disposable structures could then easily be obtained by imprinting the complementary mold topology into silicon elastomer (PDMS) (FIG. 10 B). In this routine, 2-3 mL of viscous elastomer kit (Sylgard 184 (Dow Corning)) with a mixing ratio of 10:1 of component A/B (A, silicone prepolymer; B, curing agents) was poured onto the structure and hardened for 20 min at 120° C. The hardened elastomer could then easily be peeled off the structure, cut to any desired sizes and punched from the top for introducing the liquid. Finally, it could be sealed with a thin glass plate for excellent adaptation to the optical detection system, which was realized simply by manually pressing a coverslip of 170 μm thickness to the channel top. The adhesion forces between the silicon elastomer and the glass coverslip rendered the channels sufficiently tight for the here-applied pressures on the fluidic sample. Without further treatment, the channels could then be filled with any buffer solution, containing reagents, here exemplified with fluorescent microspheres of 1.0 μm diameter (Molecular Probes).

Here, the PDMS stamp is created in a T-shape as shown in the LSM image (FIG. 10C).

While the invention has been described in connection with specific embodiments thereof, it will be understood that it is capable of further modifications and this application is intended to cover any variations, uses, or adaptations of the invention following, in general, the principles of the invention and including such departures from the present disclosures as come within known or customary practice within the art to which the invention pertains and as may, be applied to the essential features herein before set forth, and as follows in the scope of the appended claims.

1. A method for microscopic observation of one or more objects comprising:
a) providing a support means having a surface comprising a cured resin exhibiting a pattern on said surface, said resin comprising a light emitting substance;
b) placing said one or more objects on said support; and
c) simultaneously visualizing said one or more objects and said cured resin.

2. The method as claimed in claim 1 wherein said light emitting substance is a fluorophore and wherein said step of simultaneously visualizing comprises illuminating said cured resin with light at a wavelength capable of exciting said fluorophore.

3. The method as claimed in claim 2 wherein said one or more objects are fluorescent.

4. The method as claimed in claim 3 wherein said fluorescent objects emit fluorescence at a wavelength different from said fluorophore.

5. The method as claimed in claim 1 wherein a position of said one or more objects is recorded relative to said pattern exhibited by said resin.

6. The method as claimed in claim 5 wherein said one or more objects are capable of motion and said position is measured as a function of time.

7. The method as claimed in claim 1 wherein said support means is a glass microscope slide.

8. The method as claimed in claim 1 wherein said microscopic observation is performed using a microscope selected from confocal, laser scanning and fluorescence microscope.

9. A method for calibrating a fluorescence measurement apparatus said method comprising:
a) providing a support means having a surface comprising a cured resin exhibiting a pattern and comprising a fluorophore with known fluorescence characteristics;
b) obtaining fluorescence measurements of said fluorophore with said apparatus; and
c) comparing said measurements with a least one of said known fluorescence characteristics to provide a calibration of said apparatus.

10. The method as claimed in claim 9 wherein said at least one of said known fluorescence characteristics is fluorescence intensity.

11. (canceled)

12. (canceled)

13. (canceled)

14. A method for making microstructures on an imprintable substance said method comprising:
a) providing a two-photon photopolymerizable resin;
b) curing said resin on a surface according to a desired pattern; and
c) imprinting said imprintable substance using said cured resin to obtain a pattern on said substrate corresponding to said desired pattern.

15. The method as claimed in claim 14 wherein said imprinted substance is used as a stamp to make patterns of molecules or cells on a surface by adsorbing said molecules or cells on said pattern of said substance and applying said substance on said surface thereby transferring said molecules or cells on said surface according to said pattern.

16. (canceled)

17. (canceled)

18. (canceled)

19. (canceled)

20. (canceled)

21. (canceled)

22. (canceled)

23. The method as claimed in claim 14 wherein said resin comprises a light emitting substance.

24. The method as claimed in claim 23 wherein said light emitting substance is a fluorophore.

25. A microstructured substrate made by the method as claimed in claim 14.

26. A protein coated support made by the method as claimed in claim 24.

27. The method of claim 9 wherein said support means is a fluorescence calibration plate.

28. (canceled)

29. (canceled)

30. (canceled)

31. The method of claim 1 wherein said cured resin is produced by two photon polymerization.

32. The method of claim 9 wherein said fluorescence measuring apparatus is a fluorescent microscope.

33. The method of claim 14 wherein said imprintable substance is an elastomer.
